(19) United States
(12) Patent Application Publication
(10) Pub. No.: US 2006/0283417 A1
(43) Pub. Date: Dec. 21, 2006

(54) Piston and piston apparatus

(75) Inventors: Hiroshi Yaguchi, Susono-shi (JP); Daisaku Sawada, Gotenba-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 11/410,009

(22) Filed: Apr. 25, 2006

(30) Foreign Application Priority Data
Jun. 15, 2005 (JP) 2005-175564

(51) Int. Cl. F02F 3/00; F01B 31/00

(52) U.S. Cl. 123/193.6; 123/193.4; 92/181 R

(57) ABSTRACT

A piston reciprocating in a cylinder includes a piston top portion receiving pressure from working fluid in the cylinder; a skirt portion opposed to an inner surface of the cylinder; an accumulation chamber partition which is provided in an inner space of the skirt portion in non-contact manner as a structure independent from the skirt portion, partitions the inner space of the skirt portion, and forms an accumulation chamber into which gas in a working space in the cylinder is introduced; and a gas discharging hole which is provided in the skirt portion, and discharges gas in the accumulation chamber to form a gas bearing between the cylinder and the piston.

### BACKGROUND OF THE INVENTION

1. Field of the Invention

The present invention relates to a piston and a piston apparatus, and more particularly, to a piston and a piston apparatus capable of suppressing effects of deformation of a piston top portion on a skirt portion.

2. Description of the Related Art

A piston apparatus in which a piston reciprocates in a cylinder is widely used in an engine such as a gasoline engine, a diesel engine and a Stirling engine, or a piston type compressor and the like. The Stirling engine has high theoretic thermal efficiency, and can be driven using not only fuel but also exhaust gas of an internal combustion engine and the like. Therefore, the Stirling engine receives attention as an exhaust heat recovery apparatus. Japanese Patent Application Laid-Open (JP-A) No. 2004-176573 discloses a technique in which a pin boss is formed at a position away from a skirt portion so that explosion load or its stress applied to a piston head is not transmitted to the skirt portion of the piston.

When exhaust heat is to be recovered from exhaust gas of an internal combustion engine using the Stirling engine as a piston apparatus, it is necessary to recover thermal energy from a low quality heat source. Hence, it is conceived that an accumulation chamber is provided in a piston and gas is discharged into a fine clearance formed between the piston and a cylinder from the accumulation chamber, so that a gas bearing is formed between the piston and the cylinder and thus friction therebetween is reduced. In this case, the clearance between the piston and the cylinder is about several tens μm.

When a gas bearing is to be formed between the piston and the cylinder, since a clearance between the piston and the cylinder is very small, there is an adverse possibility that the gas bearing can not sufficiently exhibit) its function when the skirt portion is deformed even very slightly. The technique disclosed in JP-A No. 2004-176573 is not under the assumption that the accumulation chamber is formed in the piston and the gas bearing is formed between the piston and the cylinder.

Therefore, when the accumulation chamber is to be formed in the piston, in order to reduce the effect of deformation of the piston top portion on the skirt portion of the piston, the conventional structure is susceptible to improvement. When thermal energy is to be recovered from a low quality heat source, it is necessary to reduce the weight of moving parts of the piston, and to enhance the recovery efficiency of the exhaust heat.

### SUMMARY OF THE INVENTION

Hence, the present invention has been achieved in order to solve the above problems. It is an object of this invention to provide a piston and a piston apparatus in which when a gas bearing is to be formed between a piston and a cylinder by gas discharged from an accumulation chamber formed in the piston, at least one of reduction of effect of deformation of the piston top portion on the skirt portion and reduction in weight of the piston can be achieved.

In order to achieve the above object, a piston reciprocating in a cylinder according to one aspect of the present invention includes a piston top portion receiving pressure from working fluid in the cylinder; a skirt portion opposed to an inner surface of the cylinder; an accumulation chamber partition which is provided in an inner space of the skirt portion in non-contact manner as a structure independent from the skirt portion, partitions the inner space of the skirt portion, and forms an accumulation chamber into which gas in a working space in the cylinder is introduced; and a gas discharging hole which is provided in the skirt portion, and discharges gas in the accumulation chamber to form a gas bearing between the cylinder and the piston.

According to this piston, the accumulation chamber partition is provided in the skirt portion of the piston, the accumulation chamber into which gas in the working chamber is introduced is formed, the gas is discharged from the accumulation chamber, the gas bearing is formed between the piston and cylinder, and the skirt portion and the accumulation chamber partition are not connected with each other. With this structure, influence of deformation of the piston top portion transmitted to the skirt portion through the accumulation chamber partition can be suppressed.

A piston reciprocating in a cylinder according to another aspect of the present invention includes a piston top portion receiving pressure from working fluid in the cylinder; a skirt portion which has a structure separate from the piston top portion, is opposed to an inner surface of the cylinder, and has an end assembled to the piston top portion; an accumulation chamber which is provided in the skirt portion and into which gas in a working space in the cylinder is introduced; and a gas discharging hole which is provided in the skirt portion, and discharges gas in the accumulation chamber to form a gas bearing between the cylinder and the piston.

In this piston, the piston top portion and the skirt portion are separate and independent structures, and they are assembled to form the piston. With this, the skit can be isolated from the piston top portion mechanically and thus, influence of deformation of the piston top portion transmitted to the skirt portion from the piston top portion can be suppressed.

The piston may further include an accumulation chamber partition which is provided in an inner space of the skirt portion as a structure independent from the skirt portion, and partitions the inner space of the skirt portion. The accumulation chamber may be formed by the accumulation chamber partition.

The piston may further include a conical piston top support portion which is provided on the opposite side from a pressure-receiving surface of the piston top portion and which supports the top portion.

In the piston, the accumulation chamber partition may be sandwiched between the piston top portion and an accumulation chamber partition fixing portion which is assembled on the opposite side from a pressure-receiving surface of the piston top portion.

In the piston, the accumulation chamber partition fixing portion may be screwed into the piston top portion, thereby assembling the accumulation chamber partition on the opposite side from the pressure-receiving surface of the piston top portion.

In the piston, the accumulation chamber partition may be directly assembled on the opposite side from the pressure-receiving surface of the piston top portion.

In the piston, the accumulation chamber partition may be assembled by screwing-in operation.

A piston reciprocating in a cylinder according to still another aspect of the present invention includes a piston top portion receiving pressure from working fluid in the cylinder; a conical piston top support portion which is provided on the opposite side from a pressure-receiving surface of the piston top portion and supports the top portion; and a skirt portion which is opposed to an inner surface of the cylinder, and includes a gas discharging hole which discharges gas in a working space in the cylinder from an accumulation chamber provided inside.

This piston includes the conical piston top support portion which is provided on the opposite side from a pressure-receiving surface of the piston top portion and which supports the top portion. With this, rigidity of the piston top support portion is secured, a load applied to the piston top portion is supported, and the entire piston can be reduced in weight.

A piston apparatus according to still another aspect of the present invention includes the piston reciprocating in the cylinder according to the present invention, and a crankshaft which converts reciprocation of the piston into rotational motion.

The piston apparatus may further include a heat exchanger including a heater, a regenerator and a cooler, and working fluid sent from the heat exchanger is introduced into the cylinder, thereby driving the piston.

According to the present invention, when a gas bearing is to be formed between a piston and a cylinder by gas discharged from an accumulation chamber formed in the piston, effect of deformation of the piston top portion on the skirt portion can be suppressed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view showing a Stirling engine which is a piston apparatus of a first embodiment;

FIG. 2 is an explanatory view of a gas bearing which supports a piston;

FIG. 3A is a sectional view showing a structure of the piston of the Stirling engine according to the first embodiment;

FIG. 3B is a plan view of the piston of the Stirling engine according to the first embodiment as viewed from the top surface;

FIG. 4A is an explanatory view showing an example of disposition of gas discharging holes of the piston of the Stirling engine according to the first embodiment;

FIG. 4B is an explanatory view showing another example of disposition of gas discharging holes of the piston of the Stirling engine according to the first embodiment;

FIG. 5 is a schematic diagram showing a supporting structure of the piston top portion by a piston top support portion of the piston according to the first embodiment;

FIG. 6A is an explanatory diagram of the piston top support portion according to a modification of the first embodiment;

FIG. 6B is an explanatory diagram of the piston top support portion according to a modification of the first embodiment;

FIG. 7A is a sectional view showing a structure of a piston according to a second embodiment;

FIG. 7B is a plan view of the piston according to the second embodiment as viewed from the piston top portion surface; and

FIG. 8 is an explanatory diagram showing an assembling structure of the skirt portion of the piston according to a modification of the second embodiment.

### DETAILED DESCRIPTION OF THE PREFERRED EMBODIMENTS

The present invention will be explained in detail with reference to the drawings. The invention is not limited by the best mode for carrying out the invention (embodiment, hereinafter). Constituent elements that can easily be achieved by a person skilled in the art or that are substantially the same as conventional elements are included in constituent elements of the embodiment. In the following explanation, a Stirling engine is described as one example of the piston apparatus of the invention, but the piston apparatus is not limited to the Stirling engine.

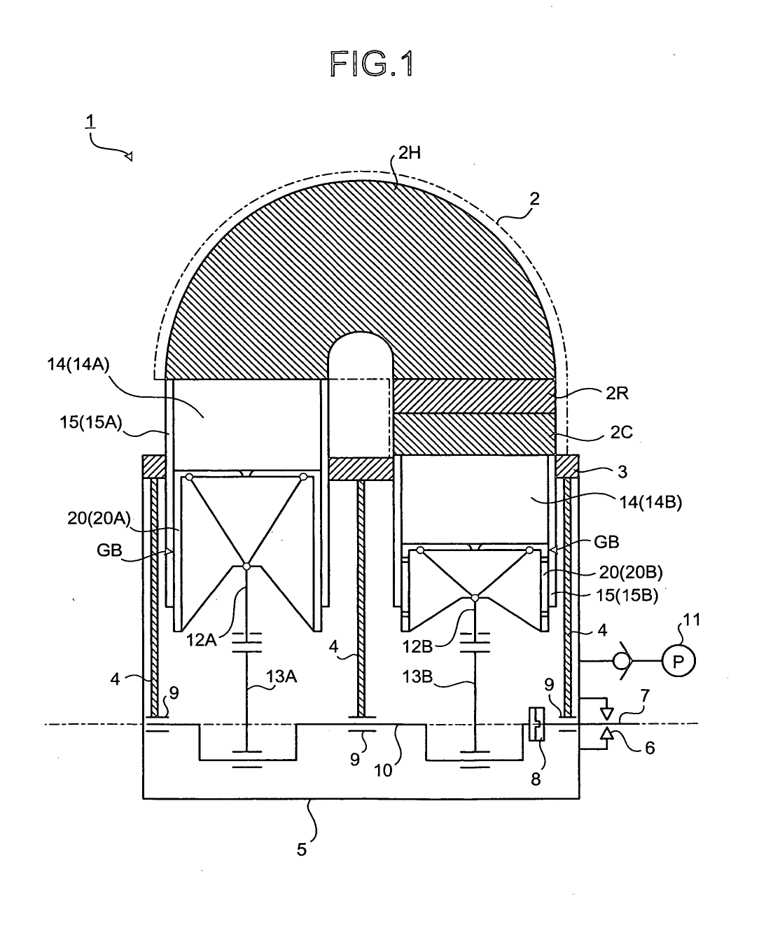

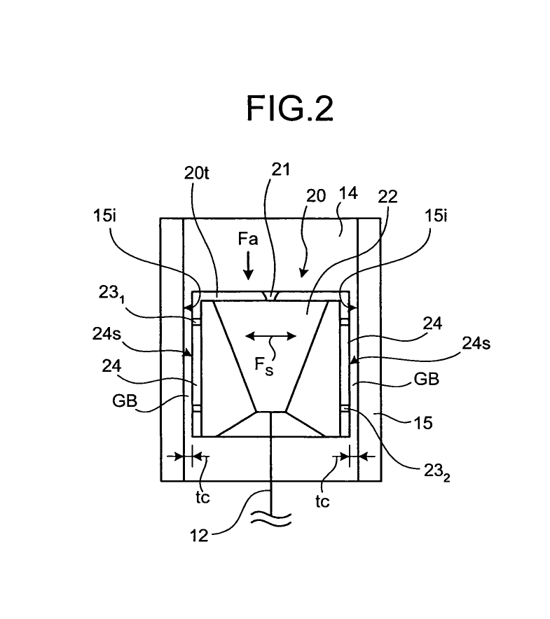

A piston and a piston apparatus having the same according to a first embodiment are characterized in that an accumulation chamber partition is provided in a skirt portion to form an accumulation chamber in the piston, and the skirt portion and the accumulation chamber partition are not connected to each other. FIG. 1 is a sectional view showing a Stirling engine which is a piston apparatus according to the first embodiment. FIG. 2 is an explanatory view of a gas bearing which supports the piston. First, a Stirling engine as the piston apparatus of the embodiment will be explained.

A Stirling engine 1 which is a piston apparatus according to this embodiment is a so-called α-type in-line two-cylinder Stirling engine. A high-temperature side piston 20A which is a first piston is accommodated in a high-temperature side cylinder 15A which is a first cylinder. A low-temperature side piston 20B which is a second piston is accommodated in a low-temperature side cylinder 15B which is a second cylinder. The high-temperature side piston 20A and the low-temperature side piston 20B are disposed in series. The high-temperature side cylinder 15A and the low-temperature side cylinder 15B are called cylinders 15, and the high-temperature side piston 20A and the low-temperature side piston 20B are called pistons 20 as required.

The high-temperature side cylinder 15A and the low-temperature side cylinder 15B are supported by and fixed to a board 3 which is a reference body. In the Stirling engine 1 of this embodiment, the board 3 is a position reference for various constituent elements of the Stirling engine 1. With this structure, relative positional precisions of the constituent elements can be secured. As will be described later, the Stirling engine 1 of the embodiment, gas bearings GB are interposed between the high-temperature side cylinder 15A and the high-temperature side piston 20A, and between the low-temperature side cylinder 15B and the low-temperature side piston 20B. The high-temperature side cylinder 15A and the low-temperature side cylinder 15B are directly or indirectly mounted on the board 3 which is the reference body. With this, a clearance can precisely be held between the piston 20 and the cylinder 15 and thus, the function of the gas bearing GB can sufficiently be exhibited. It also becomes easy to assemble the Stirling engine 1. When the Stirling engine 1 is used for recovering exhaust heat, there is a merit that the board 3 can be used as a reference when the Stirling engine 1 is mounted on an exhaust passage or the like.

The high-temperature side cylinder 15A and the low-temperature side cylinder 15B are connected to each other through the heat exchanger 2 comprising a heater 2H, a regenerator 2R and a cooler 2C. Here, one end of the heater 2H is connected to the high-temperature side cylinder 15A, and the other end of the heater 2H is connected to the regenerator 2R. One end of the regenerator 2R is connected to the heater 2H, and the other end is connected to the cooler 2C. One end of the cooler 2C is connected to the regenerator 2R and the other end is connected to the low-temperature side cylinder 15B.

A working fluid (which is gas, and is air in this embodiment) is charged into a high-temperature side working space 14A in the high-temperature side cylinder 15A, a low-temperature side working space 14B in the low-temperature side cylinder 15B and the heat exchanger 2. Heat supplied from the heater 2H and heat discharged from the cooler 2C constitute a Stirling cycle, and this drives the high-temperature side piston 20A. Here, each of the heater 2H and the cooler 2C may comprise a plurality of tubes made of material having high thermal conductivity and excellent heat resistance. The regenerator 2R may be a porous heat-accumulation material. The structures of the heater 2H, the cooler 2C and the regenerator 2R are not limited to the examples described herein, and preferable structures may be selected in accordance with thermal conditions of subjects of the exhaust heat recovery and specification of the Stirling engine 1.

The high-temperature side piston 20A and the low-temperature side piston 20B are supported in the high-temperature side cylinder 15A and the low-temperature side cylinder 15B through the gas bearings GB. That is, the pistons are supported in the cylinders without through piston rings. With this, friction between the piston and the cylinder is reduced, and the heat efficiency of the Stirling engine 1 can be enhanced. If the friction between the piston and the cylinder is reduced, the Stirling engine 1 can be operated and exhaust heat can be recovered even under operation conditions of low heat source and low temperature difference like a case in which exhaust heat of an internal combustion engine is to be recovered.

The gas bearing GB is a so-called static pressure gas bearing. The gas bearing in this embodiment supports the piston 20 which reciprocates (the same is applied also hereinafter). That is, in this embodiment, the gas bearing has a function that gas is interposed between a pair of sliding structures, and friction is reduced (the same is applied also hereinafter).

To constitute the gas bearings GB, a clearance tc (see FIG. 2) between the piston 20 and an inner surface 15i of the cylinder 15 is set to several tens μm over the entire periphery of the piston 20. The cylinder 15 and the piston 20 may be made of metal material which can easily be machined. In this embodiment, gas (working fluid) of an accumulation chamber 22 in the piston 20 is discharged from first gas discharging holes 23₁ and second gas discharging holes 23₂ which open from a side peripheral surface 24s of a skirt portion 24 of the piston 20. With this the gas bearings GB are formed between the cylinder 15 and the piston 20. The working fluid in the working space 14 is taken into the accumulation chamber 22 from a fluid element 21 provided on a piston top portion 20t of the piston 20, and the working fluid is discharged from the first gas discharging holes 23₁ and the second gas discharging holes 23₂.

Reciprocations of the high-temperature side piston 20A and the low-temperature side piston 20B are transmitted to a crankshaft 10 respectively through a high-temperature side connecting member 12A and a high-temperature side connecting rod 13A, as well as a low-temperature side connecting member 12B and a low-temperature side connecting rod 13B. The reciprocations are converted into rotational motions. The reciprocation of the piston 20 may be transmitted to the crankshaft 10 through a grasshopper mechanism or a linear approximation mechanism such as a watt link. With this, since a side force Fs (force directed to a radial direction of the piston 20, see FIG. 2) of the piston 20 becomes almost zero. Therefore, the piston 20 can sufficiently be supported even by a gas bearing GB having the small load ability.

As shown in FIG. 1, the crankshaft 10 is rotatably supported by bearings 9 provided on a crankcase 4. The crankcase 4 is fixed to the board 3. At that time, the crankcase 4 is fixed to the board 3 independently from the high-temperature side cylinder 15A and the low-temperature side cylinder 15B, i.e., the crankcase 4 is fixed to the board 3 such that the crankcase 4 does not come into contact with the high-temperature side cylinder 15A and the low-temperature side cylinder 15B. With this structure, the influence of vibration of the crankshaft 10 and the thermal expansion of the crankshaft 10 received by the high-temperature side cylinder 15A and the low-temperature side cylinder 15B can be minimized. Therefore, the function of the gas bearing GB can sufficiently be secured.

As shown in FIG. 1, the constituent elements constituting the Stirling engine 1 such as the high-temperature side cylinder 15A, the high-temperature side piston 20A and the crankshaft 10 are accommodated in a case 5. The inside of the case 5 is pressurized by pressurizing means 11. This is because working fluids (gas and air in this embodiment) in the high-temperature side cylinder 15A and the low-temperature side cylinder 15B and the heat exchanger 2 are pressurized, and higher output is taken out from the Stirling engine 1.

According to the Stirling engine 1 of this embodiment, a seal bearing 6 is mounted on the case 5, and an output shaft 7 is supported by the seal bearing 6. The output shaft 7 and the crankshaft 10 are connected to each other through a flexible coupling 8, and the output of the crankshaft 10 is transmitted through the flexible coupling 8 outside from the case 5. In this embodiment, an Oldham coupling is used as the flexible coupling 8. Next, the piston 20 of the Stirling engine 1 according to this embodiment will be explained in more detail.

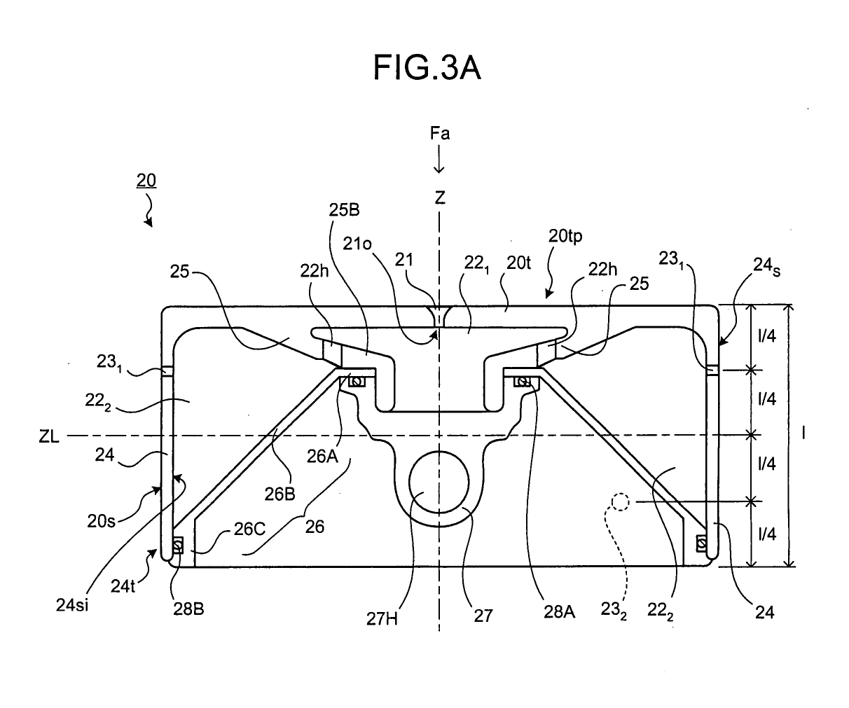

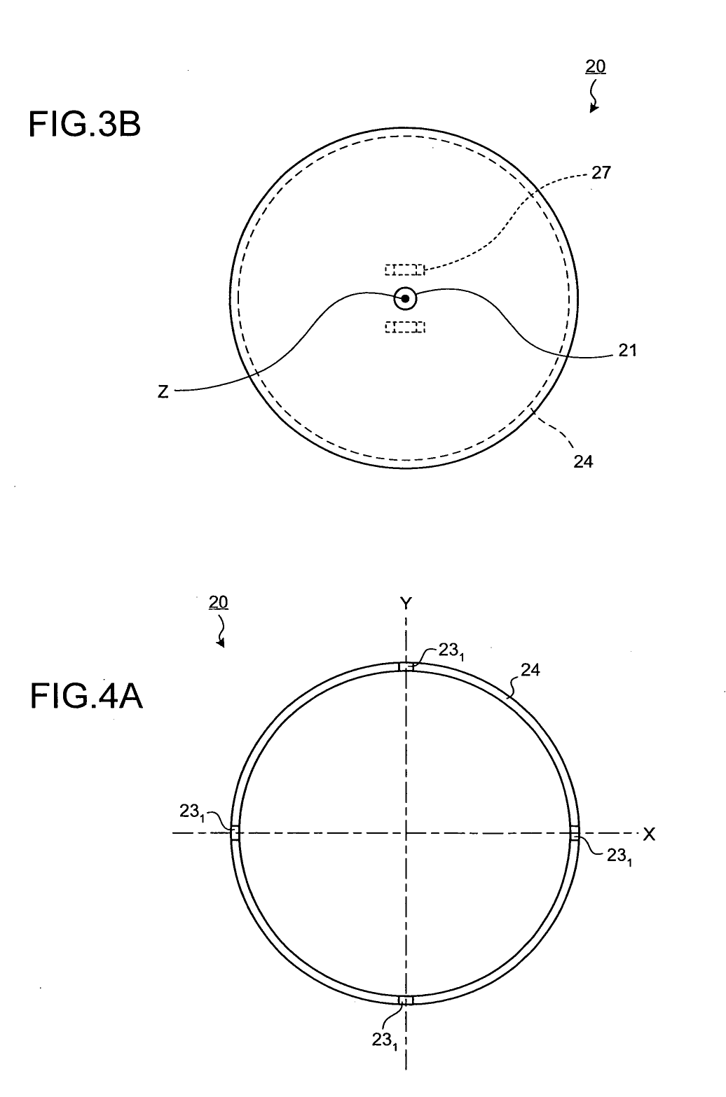

FIG. 3A is a sectional view showing a structure of the piston of the Stirling engine according to the first embodiment. FIG. 3B is a plan view showing the piston of the Stirling engine of the first embodiment as viewed from a top of the piston. FIGS. 4A and 4B are explanatory diagrams showing examples of disposition of the gas discharging holes of the piston of the Stirling engine according to the first embodiment. See FIGS. 1 and 2 for the following explanation.

According to the piston 20 of the embodiment, the piston top portion 20t and one end of the skirt portion 24 opposed to an inner surface 15i (see FIG. 2) of the cylinder 15 are connected, and the piston top portion 20t and the skirt portion 24 are integrally formed together. A piston top portion surface (pressure-receiving surface) 20tp of the piston top portion 20t receives pressure of the working fluid in the working space 14. Therefore, the piston top portion 20t is formed such that the piston top portion 20t can withstand the axial force Fa generated by the pressure. The skirt portion 24 is formed such that the piston top portion 20t can withstand pressure of the working fluid introduced into a later-described second accumulation chamber 22₂. The skirt portion 24 is a cylindrical member, and its thickness is about 1 mm in this embodiment.

A conical piston top support portion 25 is provided on the piston top portion 20t on the opposite side from the piston top portion surface 20tp. Here, the term “conical” also includes a truncated cone (the same is applied also hereinafter). The piston top support portion 25 supports the piston top portion 20t which receives pressure of gas (working fluid) in the working space 14 (see FIG. 2), and deformation of the piston top portion 20t caused by the axial force Fa generated by the gas pressure is suppressed to the minimum level. The piston top support portion 25 constitutes a portion of the piston top portion 20t (the same is applied also hereinafter). In this embodiment, the piston top support portion 25 is integrally provided with the piston top portion 20t, but the piston top support portion 25 and the piston top portion 20t may be separate structures (the same is applied also hereinafter). The support of the piston top portion 20t by the piston top support portion 25 will be described later.

The piston top support portion 25 is hollow, and the hollow portion is a first accumulation chamber 22₁. A conical accumulation chamber partition 26 is provided in the skirt portion 24 of the piston 20, and the accumulation chamber partition 26 partitions the inner space of the skirt portion 24. A space in the skirt portion 24 partitioned by the piston top portion 20t, the skirt portion 24 and the accumulation chamber partition 26 is a second accumulation chamber 22₂. In this embodiment, the accumulation chamber comprises the first accumulation chamber 22₁ and the second accumulation chamber 22₂, but the number of accumulation chambers is not limited to this example.

The piston top support portion 25 is provided with a gas communication hole 22h. The gas (working fluid) introduced into the first accumulation chamber 22₁ from the working space 14 (see FIG. 2) flows into the second accumulation chamber 22₂ through the gas communication hole 22h. An opening area of the gas communication hole 22h is set greater than a cross section area of the fluid element outlet 21o of the fluid element 21 provided on the piston top portion 20t. With this, when the working fluid in the first accumulation chamber 22₁ moves into the second accumulation chamber 22₂, the gas communication hole 22h does not functions as a narrow portion.

The piston top portion 20t is provided with the fluid element 21 as described above. It is preferable that the fluid element 21 is provided at a position of a center axis Z of the piston 20 while taking the mass balance of the piston 20 into consideration. The fluid element 21 is set such that a flow-path resistance at the time of a reversed flowing direction (flow when working fluid flows out from the first accumulation chamber 22₁) is remarkably increased as compared with a normal flowing direction (flow when working fluid is introduced into the first accumulation chamber 22₁). A check valve using a reed valve may be provided instead of the fluid element. With this, it is possible to more efficiently take gas in the working space 14 (see FIG. 2) into the first accumulation chamber 22₁ and pressurize the gas.

When the piston 20 moves toward the top dead center, the working fluid in the working space 14 (see FIG. 2) flows into the first accumulation chamber 22₁ from the fluid element 21. Since the fluid element 21 is set such that a fluid resistance at the time of the reversed flowing direction is remarkably increased as compared with the normal flowing direction, the working fluid smoothly flows into the first accumulation chamber 22₁ from the working space 14, but the working fluid can not easily flow out from the first accumulation chamber 22₁ to the working space 14. As a result, when the piston 20 reciprocates, the pressure of the working fluid (pressure in the accumulation chamber) which is accumulated in the second accumulation chamber 22₂ through the first accumulation chamber 22₁ and the gas communication hole 22h is increased and gradually approach a given value.

The gas (working fluid) which flows into the second accumulation chamber 22₂ from the gas communication hole 22h and whose pressure is increased is discharged from the first gas discharging holes 23₁ and the second gas discharging holes 23₂ provided in the skirt portion 24. As shown in FIG. 3A, the first gas discharging holes 23₁ are provided on the side of the piston top portion 20t of the piston 20, and the second gas discharging holes 23₂ are provided on the side of the end 24t of the skirt portion of the piston 20. Here, of a piston length of the piston 20 in the center axis Z is defined as 1, a position where the piston length is ½ is defined as a center axis ZL in its longitudinal direction. Each first gas discharging hole 23₁ is provided at a position of ¼ from the center axis ZL in the longitudinal direction, and each second gas discharging hole 23₂ is provided at a position of ¼ from the center axis ZL in the longitudinal direction. With this design, the gas bearings GB can be well balanced on the side peripheral surface 24s of the skirt portion 24.

As shown in FIGS. 4A and 4B, in the piston 20 of the embodiment, the first gas discharging holes 23₁ and the second gas discharging holes 23₂ are provided four each, i.e., total eight holes are provided altogether. As shown in FIG. 4A, the first gas discharging holes 23₁ are disposed at substantially equal distances (about 90°) in the circumferential direction of the piston 20. As shown in FIG. 4B, the second gas discharging holes 23₂ are disposed at substantially equal distances (about 90°) in the circumferential direction of the piston 20. The first and second gas discharging holes 23₁ and 23₂ are deviated from each other through about 45°. With this design, the deviation of the gas bearings GB can also be reduced. The number of gas discharging holes and disposition thereof are not limited to those of this example. Next, the structure of the accumulation chamber partition 26 will be explained.

As shown in FIG. 3A, the accumulation chamber partition 26 comprises a fixing portion 26A for fixing the accumulation chamber partition 26 to the piston 20, a conical partition main body 26B, and a skirt-side seal 26C for sealing the second accumulation chamber 22₂ between the inner surface 24si of the skirt portion 24 and the skirt-side seal 26C. The fixing portion 26A of the accumulation chamber partition 26 sandwiched between a base (link fulcrum connection) 25B and a link fulcrum 27 is fixed to the piston top support portion 25. Here, the link fulcrum 27 also functions as accumulation chamber partition fixing means. The high-temperature side connecting member 12A and the low-temperature side connecting member 12B are connected to the link fulcrum 27 through a connection hole 27H formed in the link fulcrum 27.

At that time, a fixing portion-side O-ring 28A which is sealing means on the side of the fixing portion 26A is provided between the fixing portion 26A of the accumulation chamber partition 26 and the link fulcrum 27, and the fixing portion-side O-ring 28A seals the second accumulation chamber 22₂. The accumulation chamber partition 26 and the link fulcrum 27 may integrally formed together. In this case, the accumulation chamber partition 26 is directly assembled on the opposite side from the pressure-receiving surface of the piston top portion 20t.

The base 25B and the link fulcrum 27 are assembled using screw-in, press-fit, shrinkage fit, welding or the like. It is preferable that the base 25B and the link fulcrum 27 are assembled using the screw-in because it is unnecessary to take the thermal influence (thermal deformation, variation in metal composition and the like) caused by the welding, shrinkage fit and the like into consideration. The screw-in is preferable because it is easy to adjust a force applied to the skirt portion 24 through the accumulation chamber partition 26.

When the base 25B and the link fulcrum 27 are to be assembled, deformation caused at the time of assembling of both the members is limited only to the assembled portions so that the influence of the deformation exerted on the skirt portion 24 through the accumulation chamber partition 26 is minimized. Thus, in the piston 20 of the embodiment, the skirt portion 24 of the piston 20 is not connected to the accumulation chamber partition 26. Next, this structure will be explained.

As shown in FIG. 3A, a skirt-side O-ring 28B which is sealing means on the side of the skirt portion 24 is provided on an outer periphery of the skirt-side seal 26C of the accumulation chamber partition 26. The skirt-side seal 26C of the accumulation chamber partition 26 is assembled to the skirt portion 24 of the piston 20 through the skirt-side O-ring 28B in the non-contact manner. The O-ring 28B of the skirt-side seal 26C seals the second accumulation chamber 22₂ between the inner surface 24si of the skirt portion 24 and the O-ring 28B. With this, the influence of deformation which is caused when the base 25B and the link fulcrum 27 are assembled and which is exerted on the skirt portion 24 through the accumulation chamber partition 26 can be minimized.

Since the skirt portion 24 of the piston 20 and the accumulation chamber partition 26 are not connected to each other, the influence of the axial force Fa transmitted to the skirt portion 24 from the piston top portion 20t of the piston 20 through the accumulation chamber partition 26 can be minimized. With this, the deformation of the skirt portion 24 during the operation of the Stirling engine 1 having the piston 20 can be minimized, and the size precision can be maintained. As a result, the gas bearing GB formed between the side peripheral surface 24s of the piston 20 and the inner surface 15i of the cylinder 15 (see FIG. 2) can sufficiently exhibit its function. Thus, contact between the piston 20 and the cylinder 15 can be suppressed, and reduction of durability of the Stirling engine 1 can effectively be suppressed. Next, a supporting structure of the piston top portion 20t by the piston top support portion 25 will be explained.

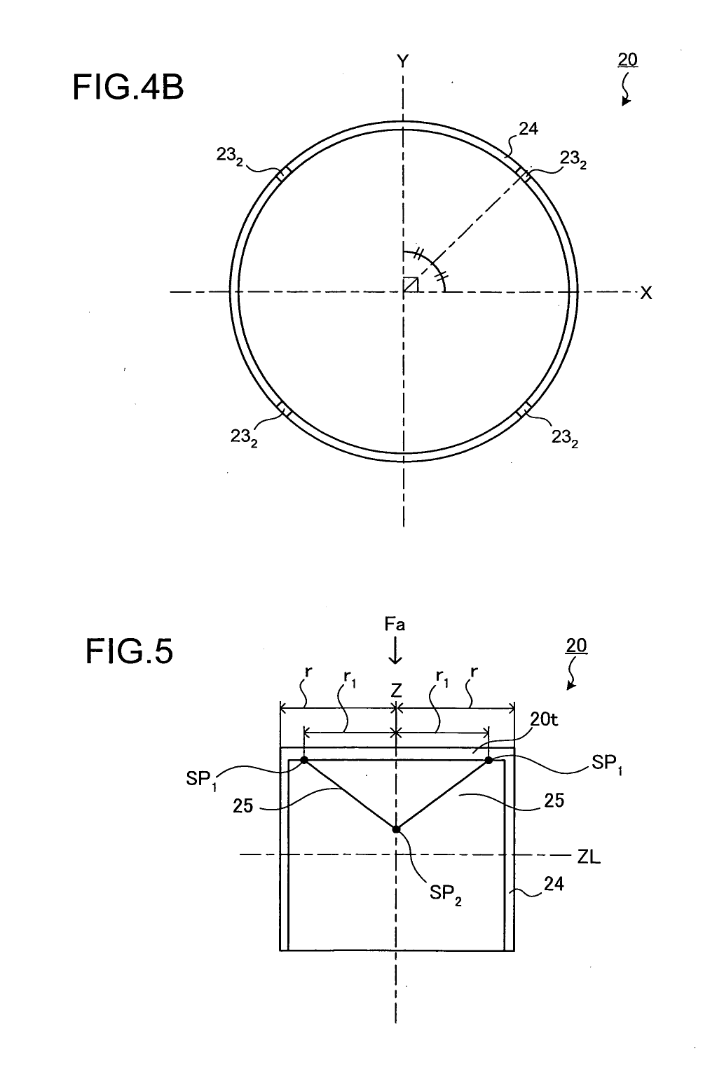

FIG. 5 is a schematic diagram showing a supporting structure of the piston top portion by the piston top support portion according to the piston of the first embodiment. As described above, the piston top portion 20t of the piston 20 of the embodiment is supported by the piston top support portion 25. The piston top support portion 25 has a conical outer shape, and supports the piston top portion 20t at a top-side fulcrum SP₁. A piston supporting load (axial force Fa or mass of the piston 20) supported by the top-side fulcrum SP₁ of the piston top support portion 25 is concentrated on a load concentrating fulcrum SP₂ of the piston top support portion 25.

Since the piston top portion 20t is supported by the conical piston top support portion 25, it is possible to secure the rigidity of the piston top support portion 25 and to lighten the entire piston 20. Since the rigidity can be secured by forming the piston top support portion 25 into the conical shape, the load applied to the piston top portion 20t can sufficiently be received by the piston top support portion 25. With this, it is unnecessary to increase the rigidity of the piston top portion 20t more than necessary, and the entire piston 20 can be lightened.

When the Stirling engine 1 is used for recovering exhaust heat, it is necessary to recovery the thermal energy from a low quality heat source. If the piston top support portion 25 is formed into the conical shape like the piston of this embodiment, it is possible to reduce the mass of the piston 20 and to enhance the recovering efficiency of exhaust heat. Therefore, this is especially effective when the Stirling engine 1 is used for recovering exhaust heat.

The load concentrating fulcrum SP₂ is provided on the center axis Z of the piston 20. When the load concentrating fulcrum SP₂ is not provided on the center axis Z of the piston 20, it is preferable that the load concentrating fulcrum SP₂ is located as close as possible to the center axis Z of the piston 20. Also, it is preferable that the load concentrating fulcrum SP₂ is located as close as possible to the center of gravity of the piston 20. With this, rocking motion of the piston 20 caused by variation in piston supporting load can be suppressed and thus, it is possible to suppress generation of galling between the piston 20 and the cylinder 15.

Since the piston top support portion 25 is of conical shape, the piston top support portion 25 is disposed symmetrically with respect to the center axis Z of the piston 20. The piston 20 is also symmetric with respect to the center axis Z. The link fulcrum 27 includes the load concentrating fulcrum SP₂. A connecting rod and load transmitting members are mounted on the link fulcrum 27. Piston supporting load concentrated on the load concentrating fulcrum SP₂ included in the link fulcrum 27 is transmitted to the connecting rod and the load transmitting members.

In the piston 20 of the embodiment, the axial force Fa and the like are supported by the above-described structure. With this, the axial forces Fa distributed symmetrically with respect to the load concentrating fulcrum SP₂ can collectively be supported by the load concentrating fulcrum SP₂. With this, the deformation amount of the piston top portion 20t caused by the pressure of the working fluid in the working space can be made symmetric with respect to the center axis Z of the piston 20 and substantially equally. As a result, the deformation amount of the piston top portion 20t caused by the pressure of gas (working fluid) in the working space which is exerted on the skirt portion 24 of the piston 20 can be made symmetric with respect to the center axis Z of the piston 20 and substantially equally. As a result, since it becomes easy to predict the deformed location and deformation amount of the skirt portion 24, its countermeasure can easily be found.

A position of the top-side fulcrum SP₁ of the piston top support portion 25 is a location where the deformation amount of the skirt portion 24 caused by the pressure of gas (working fluid) in the working space can be made as small as possible, and at least the deformation amount of the skirt portion 24 caused by pressure of gas (working fluid) in the working space can be made smaller than a permissible value. The piston 20 and the piston top support portion 25 are structures whose cross section shapes perpendicular to the center axis Z are circular. From a view point that the deformation amount of the skirt portion 24 is made as small as possible, it is preferable that a supporting radius r₁ of the top-side fulcrum SP₁ of the piston top support portion 25 in the piston top portion 20t is as close as a radius r of the piston 20. With this design, the deformation amount of the skirt portion 24 can be suppressed to an extremely small value, and the Stirling engine 1 can be operated stably.

The supporting radius r₁ of the top-side fulcrum SP₁ of the piston top support portion 25 in the piston top portion 20t is preferably greater than ½ of the radius r of the piston 20, and more preferably greater than ⅔ of the radius r of the piston 20. With this, it is possible to effectively suppress the deformation amount of the skirt portion 24, and to stably operate the Stirling engine 1.

It is preferable that the load concentrating fulcrum SP₂ (corresponding to the link fulcrum 27) is symmetric with respect to the center axis Z of the piston 20. To this end, the link fulcrum 27 is formed using a spherical seat. As shown in FIGS. 3A and 3B, the link fulcrum 27 of the piston 20 is not symmetric with respect to the center axis Z of the piston 20. In such a case, deformation of the piston 20 which is caused due to the asymmetric structure of the link fulcrum 27 with respect to the center axis Z of the piston 20 is prevented from extending toward the skirt portion 24.

To achieve this, when the link fulcrum 27 is not symmetric with respect to the center axis Z of the piston 20, it is preferable that the link fulcrum 27 is disposed at a position (position of the center axis Z of the piston 20 for example) which is away from the skirt portion 24 as far as possible. With the load concentrating fulcrum SP₂, the influence of the deformation of the piston 20 which is caused due to the asymmetric structure of the link fulcrum 27 with respect to the center axis Z of the piston 20 can be minimized with respect to the skirt portion 24, and the Stirling engine 1 can be operated stably.

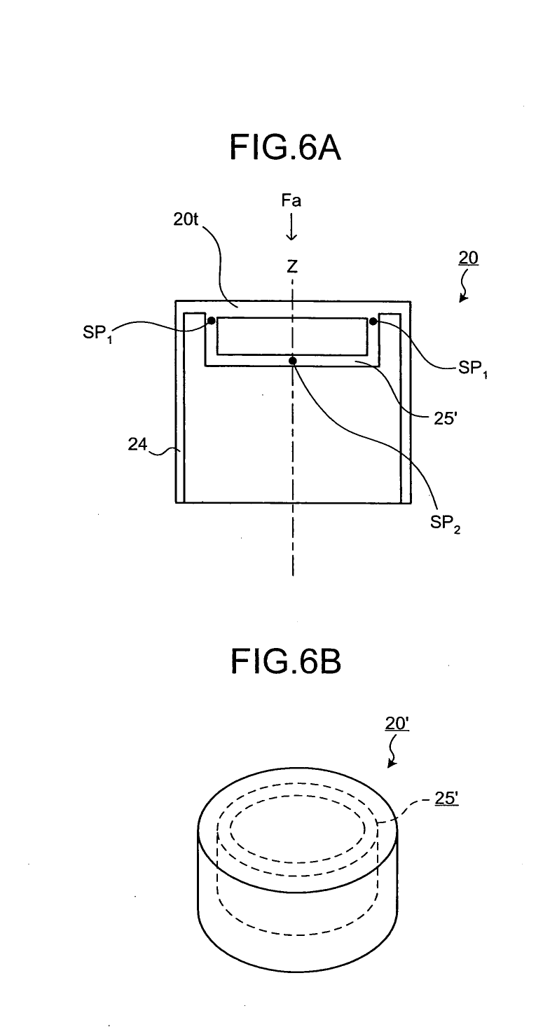

FIGS. 6A and 6B are explanatory diagrams showing examples of the piston top support portion according to modifications of the first embodiment. As shown in FIGS. 6A and 6B, a piston top support portion 25′ of a piston 20′ is of columnar shape, supports the piston top portion 20t at the top-side fulcrum SP₁, and a piston supporting load supported by the piston top support portion 25′ is transmitted to the connecting rod and other load transmitting members by the load concentrating fulcrum SP₂ of the piston top support portion 25′. With this structure also, the pressure of gas (working fluid) in the working space and axial force Fa can be received by the top-side fulcrum SP₁ of the piston top support portion 25′ and thus, it is possible to prevent the influence of deformation of the piston top portion 20t caused by the axial force Fa from extending to the skirt portion 24.

In the first embodiment and its modification, the accumulation chamber partition is provided in the skirt portion and the accumulation chamber is formed in the piston, and the skirt portion and the accumulation chamber partition are not connected with each other. With this structure, influence of deformation of the piston top portion transmitted to the skirt portion through the accumulation chamber partition can be minimized, and the number of parts constituting the piston can also be reduced. The structures disclosed in the embodiment and its modification can also be applied to the following embodiment appropriately. An idea having the same structure as those of the embodiment and the modification can exhibit the same effect and operation as those of the embodiment and the modification.

A second embodiment has substantially the same structure as that of the first embodiment, and is different from the first embodiment in that the piston top portion and the skirt portion are independent structures and they are not connected to each other. Other structure is the same as that of the first embodiment and thus, explanation thereof will be omitted, and the same constituent elements are designated with the same symbols. See FIGS. 1 and 2 for the following explanation.

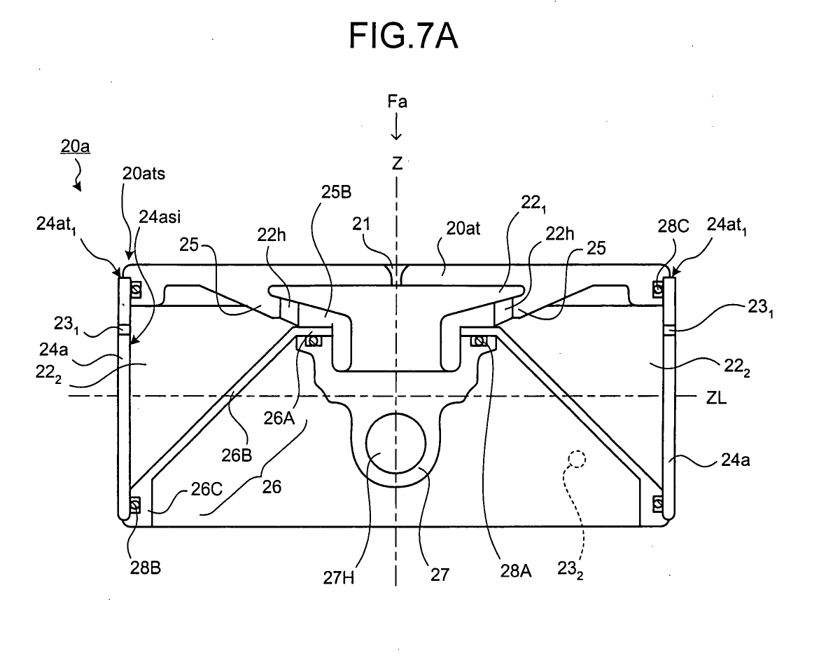

FIG. 7A is a sectional view showing a structure of the piston according to the second embodiment. FIG. 7B is a plan view of the piston of the second embodiment as viewed from the piston top portion surface. In the piston 20a, a piston top portion 20at and a skirt portion 24a are separate and independent structures. An outer periphery 20ats of the piston top portion 20at and a piston top portion side end 24at₁ of the skirt portion 24a are assembled to each other. The piston top portion 20at is a disc-like structure. The fluid element 21 is provided at the position of the center axis Z of the piston 20a. The skirt portion 24a and the piston top portion 20at are cylindrical structures which are separately and independently prepared, and thickness of each of them is about 1 mm. By forming the skirt portion 24a cylindrically, it becomes easy to machine the skirt portion 24a.

As shown in FIG. 7A, the outer periphery 20ats of the piston top portion 20at and the piston top portion side end 24at₁ of the skirt portion 24a are assembled to each other through a piston top portion-side O-ring 28C which is piston top portion-side sealing means. The piston top portion-side O-ring 28C is provided between the piston top portion 20at and the skirt portion inner surface 24asi of the skirt portion 24a. With this, the second accumulation chamber 22₂ is sealed.

In this embodiment, as shown in FIG. 7A, the skirt portion 24a is sandwiched between the piston top portion 20at and the accumulation chamber partition 26. Like the piston 20 (FIG. 3A) of the first embodiment, the fixing portion 26A of the accumulation chamber partition 26 is sandwiched between the link fulcrum 27 and the base 25B of the piston top support portion 25, and the fixing portion 26A is fixed to the piston top support portion 25. At that time, the base 25B and the link fulcrum 27 are assembled to each other by screwing-in, press-fit or the like, but if the assembling force of them is excessively strong, its influence is transmitted to the skirt portion 24a through the accumulation chamber partition 26, and the skirt portion 24a is deformed or excessive initial stress is generated. Therefore, the base 25B and the link fulcrum 27 are assembled to each other in a range not deforming the skirt portion 24a, and the accumulation chamber partition 26 is fixed.

It is preferable that the base 25B and the link fulcrum 27 are assembled using the screw-in because it is unnecessary to take the thermal influence (thermal deformation, variation in metal composition and the like) caused by the welding, shrinkage fit and the like into consideration. The screw-in is preferable because it is easy to adjust a force applied to the skirt portion 24.

The piston 20a of the embodiment is constituted in such a manner that the piston top portion 20at and the skirt portion 24a are prepared as separate and independent structures, and the outer periphery 20ats of the piston top portion 20at and the piston top portion side end 20ats of the skirt portion 24a are assembled to each other. With this, the skirt portion 24a can be independent from the piston top portion 20at, and the skirt portion 24a can be mechanically isolated from the piston top portion 20at. As a result, the influence of deformation of the piston top portion 20at on the skirt portion 24a can further be reduced. Even when the deformation amount of the piston top portion 20at is great, since the deformation is not transmitted to the skirt portion 24a almost at all, freedom degree of disposition of the top-side fulcrum SP₁ (see FIG. 5) and freedom degree of design of the piston top support portion 25 are enhanced.

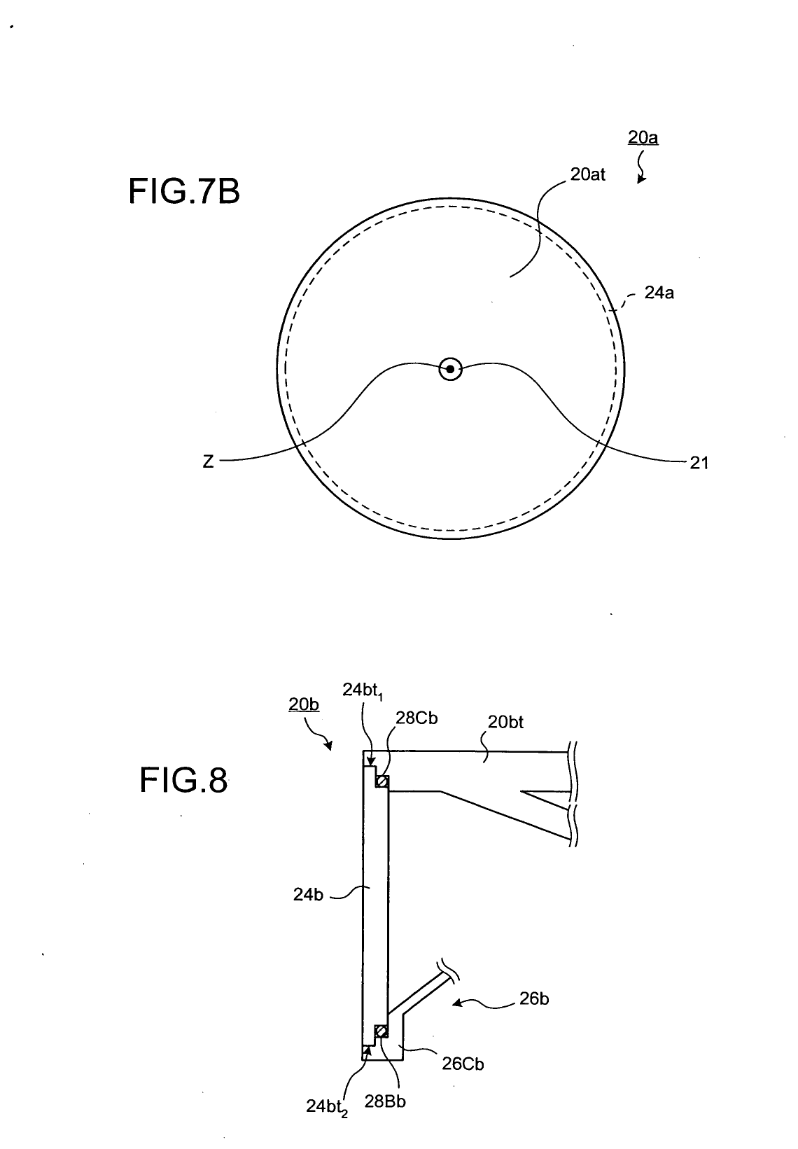

FIG. 8 is an explanatory diagram showing an assembling structure of the skirt portion of the piston according to a modification of the second embodiment. A piston 20b sandwiches a skirt portion 24b using a piston top portion 20bt and a skirt-side seal 26Cb of an accumulation chamber partition 26b. A piston top portion-side O-ring 28Cb is provided between a piston top portion-side end surface 24bt₁ and a piston top portion 20bt of the skirt portion 24b. A skirt-side O-ring 28Bb is provided between a skirt-side end surface 24bt₂ of the skirt portion 24b and a skirt-side seal 26Cb of the accumulation chamber partition 26b. With this structure, the second accumulation chamber 22₂ is sealed.

According to the piston 20b, the skirt portion 24b is sandwiched between the piston top portion 20bt and the skirt-side seal 26Cb of the accumulation chamber partition 26b through the piston top portion-side O-ring 28Cb and the skirt-side O-ring 28Bb. With this, there is a merit that the thermal expansion of the skirt portion 24b can be absorbed utilizing elasticity of the piston top portion-side O-ring 28Cb and skirt-side O-ring 28Bb.

According to the second embodiment and its modification, the piston top portion and the skirt portion are prepared as the separate and independent structures and they can be assembled to each other. With this, the skirt portion can mechanically be isolated from the piston top portion. Therefore, the influence of deformation of the piston top portion transmitted from the piston top portion to the skirt portion can further be reduced. The number of parts constituting the piston can also be reduced. An idea having the same structure as those of the embodiment and the modification can exhibit the same effect and operation as those of the embodiment and the modification.

As described above, the piston and the piston apparatus of the present invention are effective for a structure which forms a gas bearing between the piston and a cylinder by gas discharged from an accumulation chamber formed in the piston, and the piston and the piston apparatus of the invention are especially suitable for suppressing influence of deformation of a piston top portion on a skirt portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A piston reciprocating in a cylinder, comprising:
a piston top portion receiving pressure from working fluid in the cylinder;
a skirt portion opposed to an inner surface of the cylinder;
an accumulation chamber partition which is provided in an inner space of the skirt portion in non-contact manner as a structure independent from the skirt portion, partitions the inner space of the skirt portion, and forms an accumulation chamber into which gas in a working space in the cylinder is introduced; and
a gas discharging hole which is provided in the skirt portion, and discharges gas in the accumulation chamber to form a gas bearing between the cylinder and the piston.

2. The piston according to claim 1, further comprising a conical piston top support portion which is provided on the opposite side from a pressure-receiving surface of the piston top portion, and supports the top portion.

3. The piston according to claim 1, wherein the accumulation chamber partition is sandwiched between the piston top portion and an accumulation chamber partition fixing portion which is assembled on the opposite side from a pressure-receiving surface of the piston top portion.

4. The piston according to claim 3, wherein the accumulation chamber partition fixing portion is screwed into the piston top portion, thereby assembling the accumulation chamber partition on the opposite side from the pressure-receiving surface of the piston top portion.

5. The piston according to claim 1, wherein the accumulation chamber partition is directly assembled on the opposite side from the pressure-receiving surface of the piston top portion.

6. The piston according to claim 5, wherein the accumulation chamber partition is assembled by screwing.

7. A piston reciprocating in a cylinder, comprising a piston top portion receiving pressure from working fluid in the cylinder;
a skirt portion which has a structure separate from the piston top portion, is opposed to an inner surface of the cylinder, and has an end assembled to the piston top portion;
an accumulation chamber which is provided in the skirt portion and into which gas in a working space in the cylinder is introduced; and
a gas discharging hole which is provided in the skirt portion, and discharges gas in the accumulation chamber to form a gas bearing between the cylinder and the piston.

8. The piston according to claim 7, further comprising an accumulation chamber partition which is provided in an inner space of the skirt portion as a structure independent from the skirt portion, and partitions the inner space of the skirt portion, wherein the accumulation chamber is formed by the accumulation chamber partition.

9. The piston according to claim 7, further comprising a conical piston top support portion which is provided on the opposite side from a pressure-receiving surface of the piston top portion, and supports the top portion.

10. A piston reciprocating in a cylinder, comprising:
a piston top portion receiving pressure from working fluid in the cylinder;
a conical piston top support portion which is provided on the opposite side from a pressure-receiving surface of the piston top portion, and supports the top portion; and
a skirt portion which is opposed to an inner surface of the cylinder, and includes a gas discharging hole which discharges gas in a working space in the cylinder from an accumulation chamber provided inside.

11. A piston apparatus comprising:
the piston according to claim 1; and
a crankshaft which converts reciprocation of the piston into rotational motion.

12. The piston apparatus according to claim 11, further comprising a heat exchanger including a heater, a regenerator and a cooler, wherein working fluid sent from the heat exchanger is introduced into the cylinder, thereby driving the piston.

13. A piston apparatus comprising:
the piston according to claim 7; and
a crankshaft which converts reciprocation of the piston into rotational motion.

14. The piston apparatus according to claim 13, further comprising a heat exchanger including a heater, a regenerator and a cooler, wherein working fluid sent from the heat exchanger is introduced into the cylinder, thereby driving the piston.

15. A piston apparatus comprising:
the piston according to claim 10; and
a crankshaft which converts reciprocation of the piston into rotational motion.

16. The piston apparatus according to claim 15, further comprising a heat exchanger including a heater, a regenerator and a cooler, wherein working fluid sent from the heat exchanger is introduced into the cylinder, thereby driving the piston.
